(19) United States
(12) Patent Application Publication
(10) Pub. No.: US 2007/0157015 A1
(43) Pub. Date: Jul. 5, 2007

(54) Methods and apparatus to optimize boot speed

(76) Inventors: Robert C. Swanson, Olympia, WA (US); Michael A. Rothman, Puyallup, WA (US); Mallik Bulusu, Olympia, WA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/321,019

(22) Filed: Dec. 29, 2005

(51) Int. Cl. G06F 9/24

(52) U.S. Cl. 713/2

(57) ABSTRACT

Methods and apparatus are disclosed to optimize boot speed. An example method disclosed herein initializes a platform, loads a configuration manager into a memory, determines a boot mode of the platform, the configuration manager selects and retrieves from the memory boot settings corresponding to the boot mode, and executes the boot instructions.

### FIELD OF THE DISCLOSURE

This disclosure relates generally to computer system boot procedures, and, more particularly, to methods and apparatus to optimize boot speed.

### BACKGROUND

Personal computers, workstations, and servers (hereinafter “computers” or “computer systems”) typically include a basic input/output system (BIOS) as an interface between computer hardware and an operating system. The BIOS includes firmware and/or software code to initialize and enable low level hardware services of the computer, such as basic keyboard, video, disk drive, I/O port, and chipset drivers for a computer motherboard. The BIOS firmware and/or software may also search the computer system hardware for peripheral cards (e.g., PCI cards) and any controllers that may reside on those cards. Such BIOS firmware and/or software code is typically stored on a flash memory in a location read and executed by the computer processor when the processor is powered-on and, subsequently, the BIOS begins computer system initialization.

The flash memory typically includes a single default firmware and/or software image unique to the specific hardware present on the computer system and will execute a power on self test (POST) for various hardware components of the computer system. In particular, the image may include a variable instructing the processor to carry out a random access memory (RAM) POST and a disk drive POST from a cold boot. Alternatively, the image may also include a variable instructing the processor to skip a POST for one or more hardware devices during a warm boot, thereby reducing boot time.

In a manufacturing and testing environment, such as a factory where computers are assembled and tested, the BIOS single image of defaults begins the basic computer system initialization process described above until an alternate boot mode is detected. Alternate boot modes serve various purposes, including alternate variable settings that dictate specific hardware POST instructions. For example, a “normal” boot mode may not require a thorough POST process, while a “manufacturing” boot mode may require an exhaustive POST process to verify satisfactory quality initiatives are met before a manufactured computer product is shipped. When the alternate boot mode is detected (e.g., “manufacturing” mode) after basic initialization, a system reset is required before variables associated with the alternate mode may be executed. Such system resets are time consuming because they duplicate the basic initialization previously performed and reduce the number of personal computers, workstations, and/or servers that can be manufactured per unit of time.

Manufacturers of enterprise class servers are particularly concerned with the amount of time consumed during the boot process. Computer/server systems that boot faster and with fewer resets are more likely to satisfy rigorous metrics of “high availability servers.” A high availability server is defined by its ability to be up and running 99.999% of the time during a year. This high standard translates into a limit of no more than approximately five minutes of downtime per year. As a result, computer technicians in the field may have a need to restart/boot the computer/server system without employing the exhaustive POST procedures, or even the POST procedures of a normal mode. Instead, the computer technician may restart or boot the computer/server in a fast boot mode to get it up and running as quickly as possible.

### BRIEF DESCRIPTION OF THE DRAWINGS

FIG. 1 is a flow chart illustrating a prior art BIOS boot process.

FIG. 2 is a flow chart illustrating an example disclosed process to optimize BIOS boot speed.

FIG. 3 is a block diagram of an example system for optimizing boot speed.

FIG. 4 is a block diagram showing an example implementation of the BIOS Configuration Manager of FIG. 3.

FIG. 5 is a schematic illustration of an example computer that may execute the process of FIG. 2 to implement the apparatus of FIGS. 3 and 4.

### DETAILED DESCRIPTION

Generally speaking, each computer system has a particular set of hardware that, when working together, allows the computer system to execute an operating system. Such computer systems may include personal computers, workstations, PDAs, kiosks, and servers. Furthermore, upon successful initiation of an operating system, then the computer system may thereafter execute particular user applications, such as word processing applications, spreadsheet applications, Internet browser applications, games, and/or other custom and commercial applications. Prior to executing the applications, the operating system typically initializes and takes control of the computer system hardware, including hard drive(s), memory, network/graphics/audio cards, etc. Because the operating system is itself a software application read from a hard drive, a base level initialization of the underlying hardware is initialized via basic input/output system (BIOS) procedures before the operating system may take overall control of the computer system. Base level computer system components may include, but are not limited to, main memory (RAM), a central processing unit (CPU), and various chipsets.

Power on self test (POST) procedures are programs that check hardware to ensure everything is present and working properly before loading the operating system. When problems are detected as a result of POST, the computer/server system typically emits simple beeps from a speaker because the video drivers may not yet be operating to show any errors. Various BIOS manufacturers have unique beep codes that allow diagnostics without system video capabilities.

While a computer system may contain many more types of hardware components, such as advanced graphics cards (AGP cards), sound cards, peripheral component interconnect (PCI) cards, and small computer system interface (SCSI) devices, early initialization addresses the minimum requisite hardware components necessary for overall system initialization without consuming significant time. For example, the computer/server system chipset is an important group of components for proper CPU operation. The chipset(s) typically controls data transfers between the CPU, cache, system buses, and peripherals. Chipsets may also be specialized to address various facets of the computer/server system, such as a keyboard/mouse controller, an I/O chipset to handle input and output from the serial ports, parallel ports, and/or floppy disks.

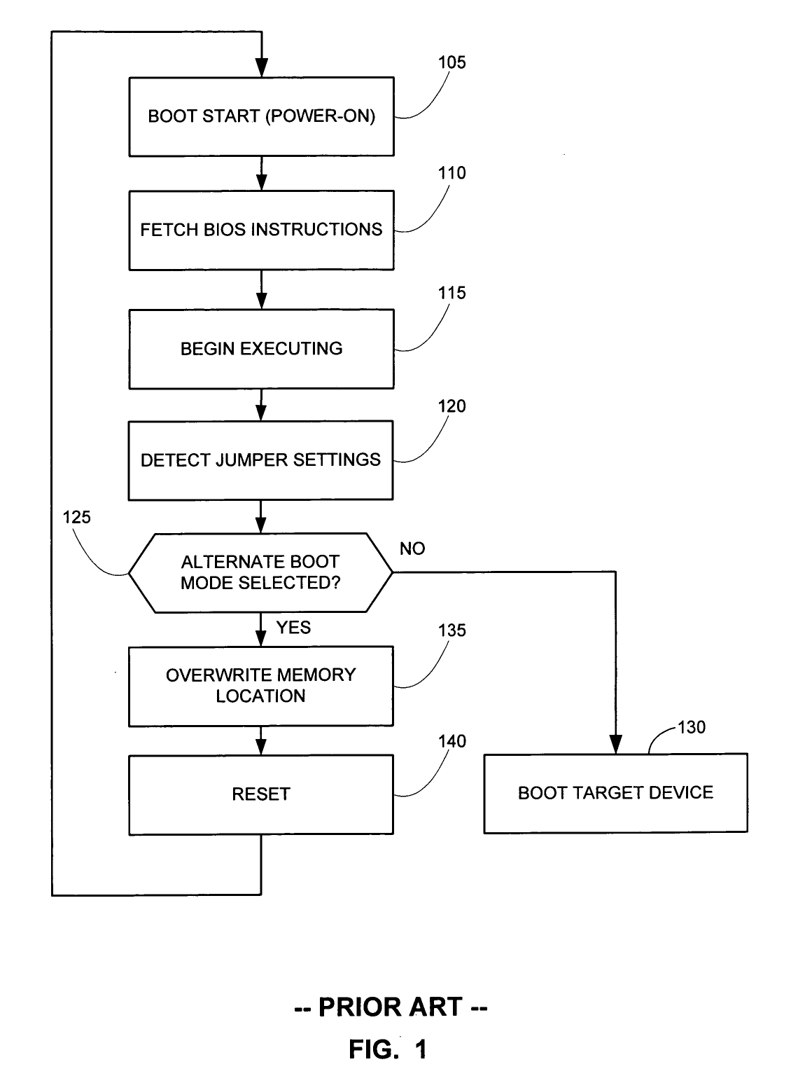

FIG. 1 is a flowchart of a known computer system BIOS boot process 100. The boot process 100 begins upon power-up (block 105) of the computer system in which a processor and/or central processing unit (CPU) is hard-coded to access a specific memory location. In particular, the chipset or CPU is typically hard-coded to fetch the first BIOS boot instructions during power-up at the top of an addressable memory (block 110). The conventional BIOS boot process 100 of FIG. 1 may begin executing BIOS boot instructions (block 115) located at the addressable memory location, sometimes referred to as a “jump” location, regardless of any alternate BIOS boot mode settings that may be set. Alternate BIOS boot mode settings, if selected, typically operate based on jumper settings on a motherboard of the computer system. However, such alternate jumper settings (e.g., a manufacturing mode) are not detected early in the boot process because the motherboard section containing the jumpers is not, itself, initialized. As a result, when alternate BIOS boot mode settings are present, valuable time is wasted executing instructions of the BIOS boot process that will be repeated after the alternate BIOS boot mode settings are detected and implemented.

After the processor has completed basic initialization, the processor detects jumper settings indicating alternate boot modes (block 120). After the jumper settings are detected (block 120), the conventional BIOS boot process 100 determines whether an alternate boot mode has been selected (block 125). If an alternate boot mode is not detected, the process 100 continues executing the boot instructions (block 130). Otherwise, the requested BIOS boot mode settings are copied from a memory (e.g., a location of flash memory) and written to the memory location pointed-to by the “jump” location (block 135). This memory read and write operation results in additional time consumed as a result of failing to execute boot instructions of the selected mode. More time is subsequently consumed upon completion of the memory read and write operation by way of a processor reset operation (block 140).

After the reset (block 140), control returns to block 105 and the conventional BIOS boot process 100 repeats. During this subsequent iteration through the process 100, the new instructions located at the destination of the “jump” location are executed to put the processor in an alternate BIOS boot mode, during which various POST procedures can be carried out. However, when this alternate BIOS boot mode is no longer desired (e.g., the manufacturing process is over), the jumper settings are restored to the previous setting and, upon power-up, the process 100 begins executing the unwanted instructions previously written to the “jump” location, even though the boot mode has changed because the CPU is unaware of the change. After the appropriate motherboard circuitry is initialized to discover alternate boot mode settings (e.g., normal mode), another memory re-write operation and reset occurs, thereby resulting in additional wasted time. Furthermore, read and write operations of BIOS instructions pose an added risk of BIOS corruption that may potentially render the computer system unbootable.

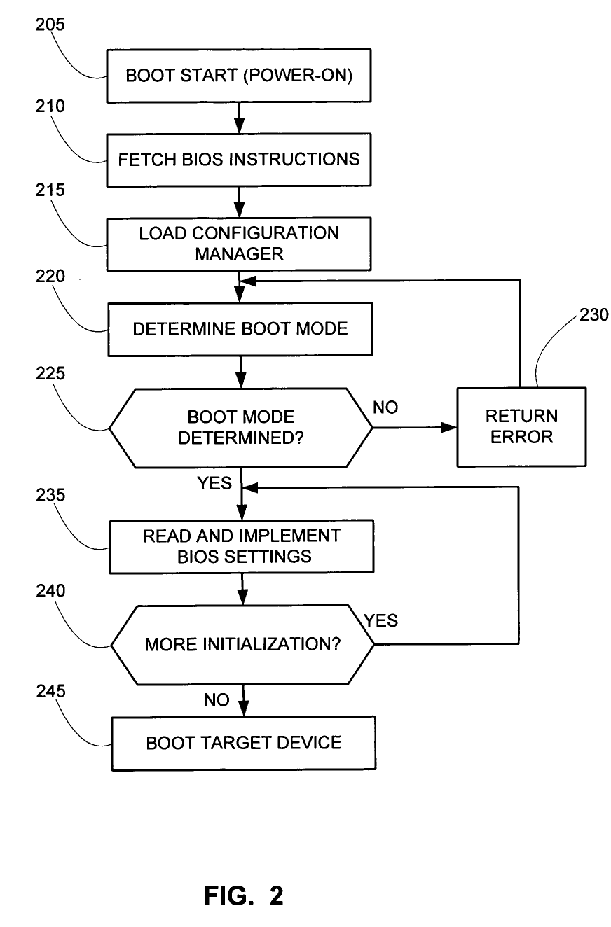

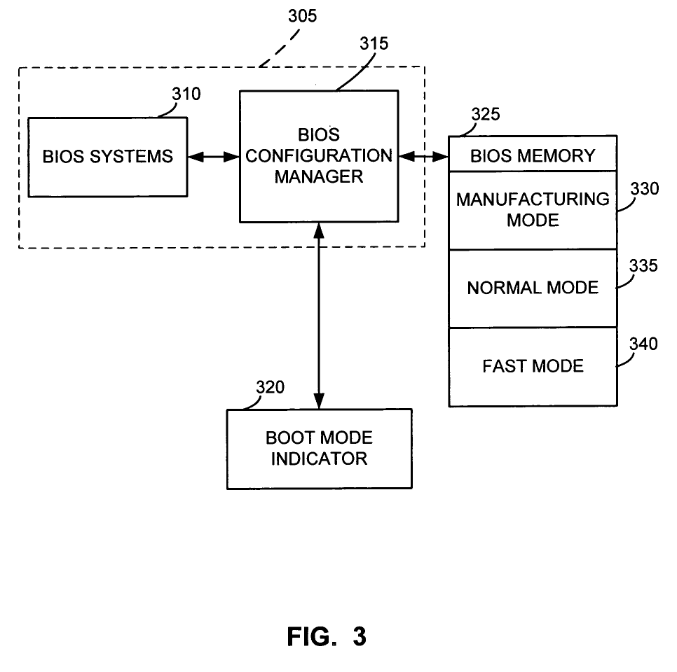

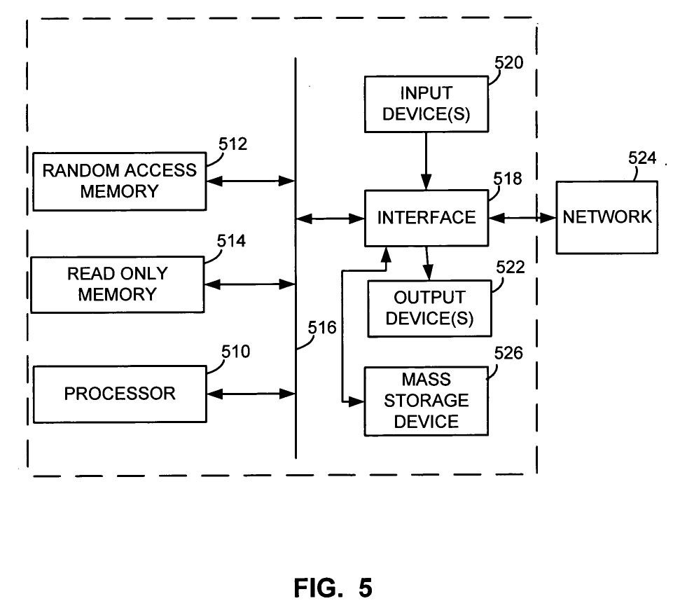

FIG. 2 is a flowchart of an example process 200 to optimize BIOS boot speed. Unlike the prior art conventional BIOS boot process 100 of FIG. 1, FIG. 2 illustrates neither a recursive process, a need for a memory re-write operation, nor multiple resets. The process 200 may be carried out by one or more components of FIGS. 3-5, as will be discussed in further detail below. Certain blocks of the process 200 may be carried out by such components and/or a processor, such as that illustrated in FIG. 5. Further, some parts of the process 200 may be carried out manually or may be implemented using hardware, software, firmware, or any suitable combination thereof.

The process 200 begins with power-up (block 205) of a computer system, which may include additional peripherals that maintain and execute independent BIOS procedures. Such peripherals may include advanced graphics cards, networking cards, and SCSI devices. Whether the boot start is a computer system or a peripheral device having its own BIOS procedures (e.g., an advanced graphics card), low level initialization of the chipset issues a reset to a CPU (and/or a microprocessor, and/or a microcontroller) when adequate power is available for the CPU. Although the CPU is ready to execute, it has no instructions at the very early stages of the BIOS boot procedures. As such, the CPU typically begins execution at a memory location/address hard-coded by the CPU or chipset (block 210). Such memory locations may be chipset and/or CPU dependent or compatible with industry standard locations. By way of illustration, and not limitation, a hard-coded memory location/vector may be close to the end of the memory and then “jump” to an alternate memory location for further instructions.

During the early BIOS boot procedures, a BIOS configuration manager (discussed in further detail below) is loaded into memory (e.g., RAM) at block 215 for execution by the CPU. The configuration manager remains resident during the boot process and may, among other things as discussed below, initialize various chipsets and/or motherboard facilities at an early stage of the computer system initialization. The configuration manager determines whether a selected boot mode is present at block 220. As discussed in further detail below, the configuration manager may employ a BIOS interface to access a boot mode detector that detects inputs from a boot mode indicator. The boot mode indicator may compare the inputs (e.g., jumper settings, in circuit probe, etc.) against a boot mode list to determine whether a valid input selection exists. Such jumper settings and/or in-circuit probe inputs may be available as a result of the aforementioned efforts of the configuration manager initializing the various chipsets and/or motherboard facilities. If the inputs from the boot mode indicator do not match one of the BIOS modes listed in the boot mode list, then an error message is returned to the BIOS interface (block 230). An error message may not be indicative of a total boot failure, rather, the error message may indicate that more time is necessary for base-level initialization of the hardware components, thus a mode determination is premature. Control returns to block 220 to determine the boot mode.

The configuration manager may set a counter to compare against a threshold number of attempts to determine the boot mode. If the error message at block 230 is returned more than the threshold amount, the BIOS interface may instruct the computer system to proceed in a default boot mode.

If the inputs from the boot mode indicator match one of the BIOS modes listed in the boot mode list (block 225), then a BIOS setting retriever accesses the appropriate location of a BIOS memory at block 235, and returns the settings to the BIOS interface. The BIOS interface instructs the various hardware components of the computer system pursuant to the settings retrieved by the BIOS setting retriever.

The selected settings from the BIOS memory determine the hardware to be initialized, and in which order such hardware is initialized. If additional hardware needs initialization and/or POST procedures, block 240 directs control back to block 235 to read and implement additional BIOS settings from the BIOS memory. If the BIOS settings have all been read, and the corresponding hardware has been initialized (block 240), control advances to block 245 and the computer system boots an operating system without any recursive procedures, memory rewrites, and/or multiple CPU resets.

FIG. 3 is a diagram of an example system to optimize boot speed 300, which may be implemented by firmware executed by a processor. The example system to optimize boot speed 300 includes a BIOS 305. The BIOS 305 further includes BIOS systems 310 and a BIOS configuration manager 315, as discussed above. Operatively connected to the BIOS configuration manager 315 are a boot mode indicator 320 and a BIOS memory 325. The example BIOS memory 325 further includes three example BIOS settings: a manufacturing mode setting 330, a normal mode setting 335, and a fast boot setting 340.

The BIOS systems 310 of the BIOS 305 may include BIOS for a computer system motherboard, and/or computer system peripherals, such as advanced graphics cards, network cards, memory, hard drives, and/or SCSI devices. Each of the computer system peripherals may require its own unique boot instructions for POST procedures that are stored, for example, on a memory of the peripheral device.

Upon computer system power-up, the BIOS 305 performs low level initialization procedures on, for example, the hard drive. In particular, the hard drive initializes and executes POST procedures, thereby verifying proper operation before advancing the BIOS boot procedures to subsequent steps. The hard drive may then be accessed by the computer system and the operating system is loaded. The BIOS configuration manager 315 is initialized as soon as possible after the computer system is powered-on. The BIOS configuration manager 315 may be an application programming interface (API) loaded as part of the BIOS system 310 procedure, a chipset of the motherboard, and/or an ASIC. Specific boot mode selection instructions are sent to the BIOS configuration manager 315 via the boot mode indicator 320, which may include inputs from a variety of computer system peripherals. For example, upon computer system power-up, the boot mode indicator 320 may include one or more signals, such as from a jumper setting indicative of a boot mode setting, an input from a serial/parallel port, a network card input, a keyboard/mouse input, a universal serial bus (USB) input, an infrared (IR) input signal, a setting in a memory, and/or an in-circuit probe to a location of the motherboard during in-field service and/or the manufacturing process.

Instructions for the selected boot mode are stored in the BIOS memory 325. Such instructions are obtained from the BIOS memory 325 based on the selection(s) indicated by the boot mode indicator 320. Typically, the BIOS memory 325 is a non-volatile memory, such as ROM, EEPROM (typically referred to as flash), or complementary metal oxide semiconductors (CMOS). The BIOS memory 325 is typically located in a socket on the motherboard and labeled as such.

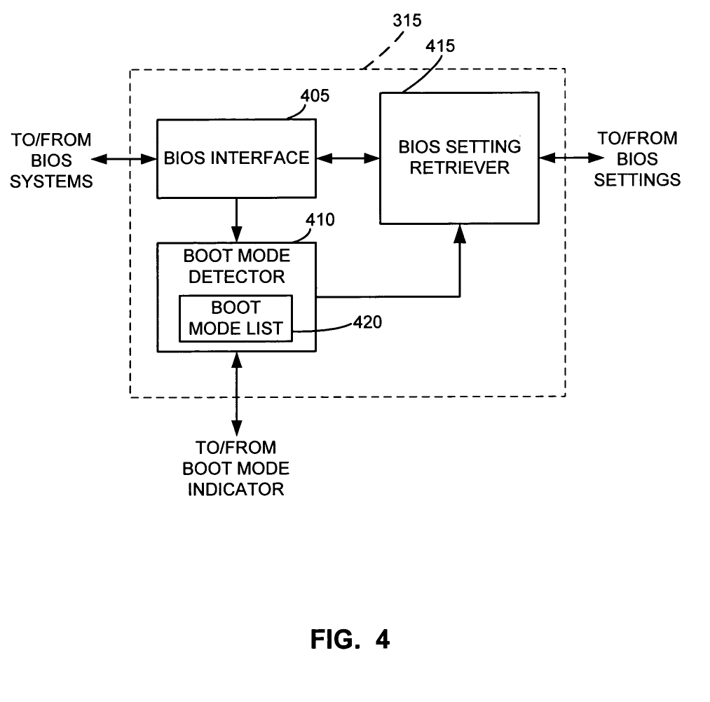

As shown in further detail in FIG. 4, the BIOS configuration manager 315 includes a BIOS interface 405, a boot mode detector 410, and a BIOS setting retriever 415. The BIOS interface 405 receives signals from the BIOS systems 310 that BIOS procedures should execute. As discussed above, such BIOS procedures typically begin execution from a reset vector in BIOS memory 325 that may or may not be the same for all computer systems. The CPU looks at the hard-coded memory location upon power-up for instructions and may further “jump” to an alternate memory location where the boot procedures are located.

Selectable boot modes are important for proper computer system operation depending on various environmental conditions. For example, a normal boot mode 335 includes various settings to instantiate standard POST.procedures, such as those typically executed in a home or business environment by a home or business user of a computer product (e.g., home PC, workstation, business server, etc.). A manufacturing boot mode 330 includes various settings to instantiate POST procedures associated with a manufacturing environment. For example, in view of competitive pressures to deliver high quality and fully functional products, computer manufacturers may choose to execute a more thorough series of POST procedures on the hardware components. Such exhaustive POST procedures may take additional time to complete during the manufacturing process than a normal boot mode may take, while gaining the benefit of identifying potential product defects and/or other errors before shipping the computer system to a customer. A fast boot mode 340 includes various settings to instantiate a minimum number of POST procedures, and may be particularly useful for a service technician booting in the field. Such fast boot mode settings may accommodate customers that have a high degree of confidence that various hardware components are reliable and/or not critical enough to warrant the added time necessary for a POST.

Unlike conventional BIOS systems, which proceed with a pre-determined BIOS setting after power-up, the disclosed BIOS configuration manager 315 is invoked as soon as possible after the power-up begins. The BIOS interface 405 accesses the boot mode detector 410 to determine which boot mode should be initiated by the BIOS 305. In particular, the boot mode detector 410 receives a signal from the boot mode indicator 320 that, in turn, receives a signal from the computer system to be booted. For example, in a manufacturing process, an in-circuit probe may be connected to a location of the motherboard that is initialized very early in the computer system initialization process. The in-circuit probe may inject a signal (e.g., a DC level, binary, binary coded decimal (BCD), pre-determined frequency signal, pulse code modulated signal, etc.) on the motherboard to indicate a desired BIOS setting (e.g., manufacturing mode, normal mode, fast boot mode). Alternatively, the boot mode indicator 320 may be a jumper setting, unique keyboard/mouse input signal, serial/parallel/USB port input, variable(s) stored in a memory or register, and/or a network card input signal.

Optionally, the boot mode detector 410 may include a boot mode list 420 to determine quickly whether a valid input signal is received from the boot mode indicator 320. For example, the boot mode list 420 may include three separate binary or BCD entries that correspond to three BIOS modes (330, 335, 340) of the BIOS memory 325. The manufacturing, normal, and fast mode may be, for example, a 3-bit binary number 001, 010, and 100, respectively. As a result, if an alternate, unknown, and/or absent signal is present, the boot mode detector 410 may quickly determine the anomaly and report an error, or boot in a default mode.

The selected boot mode determined by the boot mode detector 410 is sent to the BIOS setting retriever 415. The BIOS setting retriever 415 accesses the appropriate location(s) of the BIOS memory 325 to retrieve settings that correspond to the selected boot mode. Such settings are returned to the BIOS interface 405, which forwards the settings to the appropriate hardware devices for initialization.

Because the BIOS configuration manager 315 determines the correct boot mode at the beginning of the BIOS boot process, no time is wasted performing memory read/write operations, no time is wasted performing any steps of an unwanted BIOS boot mode, and no time is wasted performing multiple resets. As a result, the manufacturer in the highly competitive computer system market may save valuable time during assembly and test, while increasing the volume of units produced per unit of time.

Although the foregoing discloses example systems including, among other components, firmware and/or software executed on hardware, it should be noted that such systems are merely illustrative and should not be considered as limiting. For example, it is contemplated that any or all of these hardware and software components could be embodied exclusively in dedicated hardware, exclusively in software, exclusively in firmware, or in some combination of hardware, firmware and/or software. Accordingly, while the following describes example systems, persons of ordinary skill in the art will readily appreciate that the examples are not the only way to implement such systems.

FIG. 5 is a block diagram of an example computer 500 capable of implementing the apparatus and methods disclosed herein. The computer 500 can be, for example, a server, a personal computer, a personal digital assistant (PDA), or any other type of computing device.

The system 500 of the instant example includes a processor 510. For example, the processor 510 can be implemented by one or more Intel® microprocessors from the Pentium® family, the Itanium® family, the XScale® family, or the Centrino™ family. Of course, other processors from other families are also appropriate.

The processor 510 is in communication with a main memory including a volatile memory 512 and a non-volatile memory 514 via a bus 516. The volatile memory 512 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 514 may be implemented by flash memory and/or any other desired type of memory device. Access to the main memory 512, 514 is typically controlled by a memory controller (not shown) in a conventional manner.

The computer 500 also includes a conventional interface circuit 518. The interface circuit 518 may be implemented by any type of well known interface standard, such as an Ethernet interface, a universal serial bus (USB), and/or a third generation input/output (3GIO) interface.

One or more input devices 520 are connected to the interface circuit 518. The input device(s) 520 permit a user to enter data and commands into the processor 510. The input device(s) can be implemented by, for example, a keyboard, a mouse, a touch screen, a track-pad, a trackball, isopoint and/or a voice recognition system.

One or more output devices 522 are also connected to the interface circuit 518. The output devices 522 can be implemented, for example, by display devices (e.g., a liquid crystal display, a cathode ray tube display (CRT), a printer and/or speakers). The interface circuit 518, thus, typically includes a graphics driver card.

The interface circuit 518 also includes a communication device such as a modem or network interface card to facilitate exchange of data with external computers via a network 524 (e.g., an Ethernet connection, a digital subscriber line (DSL), a telephone line, coaxial cable, a cellular telephone system, etc.).

The computer 500 also includes one or more mass storage devices 526 for storing software and data. Examples of such mass storage devices 526 include floppy disk drives, hard drive disks, compact disk drives and digital versatile disk (DVD) drives.

As an alternative to implementing the methods and/or apparatus described herein in a system such as the device of FIG. 5, the methods and/or apparatus described herein may alternatively be embedded in a structure such as processor and/or an ASIC (application specific integrated circuit).

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of configuring a basic input/output system (BIOS), the method comprising:
initializing a platform;
loading a configuration manager into a memory;
determining a boot mode of the platform;
the configuration manager selecting and retrieving from the memory boot settings corresponding to the boot mode; and
executing the boot instructions.

2. A method as defined in claim 1 wherein the configuration manager comprises an application programming interface (API).

3. A method as defined in claim 1 wherein the configuration manager loads into the memory prior to retrieving the boot settings.

4. A method as defined in claim 1 wherein the boot mode comprises at least one of a normal boot mode, a manufacturing boot mode, or a fast boot mode.

5. A method as defined in claim 1 wherein determining the boot mode further comprises receiving a boot mode indicator signal.

6. A method as defined in claim 5 wherein the boot mode indicator signal comprises at least one of a jumper setting signal, a serial port signal, a USB port signal, a network signal, or an in-circuit probe signal.

7. A method as defined in claim 1 wherein the boot settings comprise hardware initialization instructions.

8. A method as defined in claim 7 wherein the hardware comprises at least one of a hard drive, a memory, an expansion card, a PCI card, an AGP card, a video card, an audio card, a network card, or a chipset.

9. A method as defined in claim 7 wherein the hardware initialization instructions comprise power on self test (POST) procedures.

10. A method as defined in claim 1 wherein retrieving from the memory comprises retrieving from at least one of a flash memory or complementary metal oxide semiconductors (CMOS).

11. An apparatus to configure a basic input/output system (BIOS), the apparatus comprising:
a BIOS to facilitate initialization of a device;
a BIOS configuration manager to determine a boot mode setting and obtain boot instructions;
a boot mode indicator to provide the boot mode setting; and
a storage device to store the boot instructions.

12. An apparatus as defined in claim 11 wherein the BIOS configuration manager further comprises a BIOS interface to receive a BIOS boot request signal.

13. An apparatus as defined in claim 11 further comprising a boot mode detector to determine the boot mode setting.

14. An apparatus as defined in claim 13 wherein the boot mode detector further comprises a boot mode list, the boot mode list comparing a pre-determined boot mode with the boot mode setting from the boot mode indicator.

15. An apparatus as defined in claim 13 further comprising a BIOS setting retriever, the boot mode detector identifying a boot mode to the BIOS setting retriever, the BIOS setting retriever accessing boot settings from the storage device corresponding to the identified boot mode.

16. An apparatus as defined in claim 11 wherein the boot mode indicator comprises a signal for at least one of a jumper setting, a serial port, a USB port, a network port, or an in circuit probe.

17. An apparatus as defined in claim 16 wherein the signal comprises at least one of a binary signal, a BCD signal or a pre-determined frequency signal.

18. An article of manufacturing storing machine readable instructions which, when executed, cause a machine to:
initialize a platform;
load a configuration manager into a memory;
determine a boot mode of the platform;
select and retrieve from the memory boot settings corresponding to the boot mode; and
execute the boot instructions.

19. An article of manufacture as defined in claim 18 wherein the machine readable instructions cause the machine to receive hardware initialization instructions from the boot settings.

20. An article of manufacture as defined in claim 19 wherein the machine readable instructions cause the machine to receive hardware instructions comprising power on self test (POST) procedures.

21. An article of manufacture as defined in claim 18 wherein the machine readable instructions cause the machine to receive a boot mode indicator signal.
